(19) United States
(12) Patent Application Publication
(10) Pub. No.: US 2012/0284188 A1
(43) Pub. Date: Nov. 8, 2012

(54) INTERCHANGE REPORTING MANAGER

(76) Inventors: Margaret C. Vasquez, Leesberg, VA (US); Prasad S. Deshmukh, San Ramon, CA (US); Mohana Murali Ramachandra Reddy, Foster City, CA (US)

(21) Appl. No.: 13/461,678

(22) Filed: May 1, 2012

Related U.S. Application Data
(60) Provisional application No. 61/481,611, filed on May 2, 2011.

(51) Int. Cl. G06Q 20/40

(52) U.S. Cl. 705/44

(57) ABSTRACT

For a first transaction, an authorization request message is received from a first payment processing network and transmitted to an issuer computer, and an authorization response message is received from the issuer computer and transmitted to the first payment processing network. For a second transaction, an authorization message is received from a second payment processing network and transmitted to the issuer computer, and an authorization response message is received from the issuer computer and transmitted to the second payment processing network. The authorization request and response messages for the first and second transactions include transaction data which is stored. Interchange data files including interchange data for the first and second transactions are received from first and second payment processing networks, respectively. The interchange data files are normalized, and the stored transaction data for the first and second transactions is enriched with the received interchange data.

### CROSS-REFERENCES TO RELATED APPLICATIONS

This application claims the benefit of U.S. Provisional Application No. 61/481,611, filed May 2, 2011, entitled “INTERCHANGE REPORT MANAGER,” which is herein incorporated by reference in its entirety for all purposes.

### BACKGROUND

When a consumer uses a payment card to make a purchase or withdraw funds from an automatic teller machine (ATM), the transaction is typically processed by a payment processing network. For example, a merchant's bank (the acquirer) will typically send a message requesting authorization of the transaction through a payment processing network to the bank that issued the payment card (the issuer). The issuer will send a message back through the payment processing network indicating whether the transaction is approved or declined.

Issuers must have rules in place that match each payment processing network. For example, the rules for transaction authorization, management of disputes, and handling fraudulent transactions may vary from network to network. As a result, issuers must be able to allocate resources effectively for each network.

Historically, issuers have been able to choose the payment processing networks that process their payment card transactions. Network routing decisions, however, have shifted from issuers to merchants. In order to effectively allocate resources for multiple payment processing networks, it is essential that issuers be able to track and monitor network routing decisions made by merchants.

It is also essential that issuers be able to effectively manage their interchange revenue and expenses for transactions processed across multiple networks. In a typical payment card transaction, an interchange fee is paid between banks. For example, in merchant point of sale transactions, the interchange fees are typically paid on a daily or monthly basis by the acquirer to the issuer. The payment network that processes the transaction typically deducts an additional fee (i.e. a “switch” fee) from the amount paid by the issuer to the acquirer. In other instances, the interchange fee is paid from the issuer to acquirer. For example, when a consumer withdraws funds from an ATM not operated by the issuer of the consumer's ATM card, an interchange fee is typically paid to the acquirer by the issuer.

The problems associated with managing interchange revenue and expenses over multiple networks are compounded by regulations limiting the amount of interchange revenue that can be charged by certain issuers. For example, in the United States, issuers with over $10 billion in assets are limited to $0.21 plus 5 basis points of the transaction amount for each transaction. If the issuer participates in fraud protection, an additional $0.01 is permitted per transaction. Other jurisdictions have similar regulations in place. In order to investigate and report non-compliant transactions, issuers must be made aware of such transactions in a timely manner.

Interchange reports are an essential tool for issuers to manage interchange revenue and expenses. However, issuers have generally been limited to receiving periodic summary level interchange reports from payment processing networks. Such summary level reports typically fail to provide interchange information at the transactional level (i.e. on a per transaction basis). Issuers may need to know interchange information for a specific transaction, or day-to-day interchange revenue and expenses for a particular cardholder, terminal, merchant store, merchant chain, BIN, or payment processing network. A small number of payment processing networks have begun to process interchange at the transactional level and provide this data to issuers in the form of raw data files. The raw data files, however, are typically delivered with a one or two day delay, and are of varying formats making the raw data difficult and costly to manage. These solutions often fail to provide issuers with sufficient detail to effectively manage their interchange revenue and expenses. Further, since issuers may be required by law to store interchange at the transactional level for a specified period of time (e.g., 5 years in the United States), these solutions fail to provide issuers with effective means for complying with auditing regulations.

Embodiments of the invention address the above problems, and other problems, individually and collectively.

### SUMMARY

Embodiments of the invention are related to systems and methods for enriching transaction data with interchange data for individual transactions conducted across multiple payment processing networks. As explained below, the enriched transaction data may be analyzed, and reports may be generated based upon the analysis. The reports may include interchange information (e.g., fee and transaction routing details) at various levels including: transaction, account, cardholder, terminal, merchant store, merchant chain, BIN, payment processing network, etc.

One embodiment of the invention is directed to a method comprising receiving an authorization request message for a first transaction from a first payment processing network, and transmitting the authorization request message to an issuer computer. An authorization response message for the first transaction is received from the issuer computer and transmitted to the first payment processing network. The authorization request message and authorization response message for the first transaction include transaction data for the first transaction which is stored. An authorization message for a second transaction is received from a second payment processing network and transmitted to the issuer computer. An authorization response message for the second transaction is received from the issuer computer and transmitted to the second payment processing network. The authorization request message and authorization response message for the second transaction include transaction data for the second transaction which is stored. A first interchange data file including interchange data for the first transaction is received from first payment processing network, and a second interchange data file including interchange data for the second transaction is received from the second payment processing network. The first and second interchange data files are normalized, and the stored transaction data for the first and second transactions is enriched with the received interchange data.

Another embodiment of the invention is directed to a method comprising receiving an authorization request message for a first transaction from a processor system, wherein the processor system received the authorization request message for the first transaction from a first payment processing network. An authorization response message for the first transaction is generated and transmitted to processor system, which transmits the authorization response message for the first transaction to the first payment processing network. The authorization request message and authorization response message for the first transaction include transaction data for the first transaction, and the processor system stores the transaction data for the first transaction. An authorization request message for a second transaction is received from the processor system, wherein the processor system received the authorization request message for the second transaction from a second payment processing network. An authorization response message for the second transaction is generated and transmitted to the processor system, which transmits the authorization response message for the second transaction to the second payment processing network. The authorization request message and authorization response message for the second transaction include transaction data for the second transaction, and the processor system stores the transaction data for the second transaction. The processor system receives a first interchange data filing including interchange data for the first transaction from the first payment processing network, and a second interchange data file including interchange data for the second transaction from the second payment processing network. The processor system normalizes the first and second interchange data files, and enriches the stored transaction data with the received interchange data for the first and second transactions.

These and other embodiments of the invention are described in further detail below with reference to the Figures and the Detailed Description.

### BRIEF DESCRIPTION OF THE DRAWINGS

FIG. 1 shows a block diagram of a typical payment processing system.

FIG. 2 shows a block diagram of a payment processing system according to an embodiment of the invention.

FIG. 3 shows a block diagram of components of a processor system according to an embodiment of the invention.

FIG. 4A shows a transaction data table according to an embodiment of the invention.

FIG. 4B shows an interchange data table according to an embodiment of the invention.

FIG. 4C shows an enriched transaction data table according to an embodiment of the invention.

FIG. 5 illustrates a flow diagram showing a method for enriching stored transaction data with interchange data for transactions conducted across multiple payment processing networks.

FIG. 6 shows a merchant level interchange report according to an embodiment of the invention.

FIG. 7 shows a network level interchange report according to an embodiment of the invention.

FIG. 8 shows a transaction level interchange report according to an embodiment of the invention

FIG. 9 shows a network level volume report according to an embodiment of the invention.

FIG. 10 shows a merchant level volume report according to an embodiment of the invention.

FIG. 11 shows a block diagram of a computer apparatus according to an embodiment of the invention.

### DETAILED DESCRIPTION

Prior to discussing embodiments of the invention, a further description of some terms may be helpful in understanding embodiments of the invention.

As used herein, a “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

As used herein, a “payment processing network” may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transaction, and other types of commercial transactions. VisaNet™, in particular, includes a VIP system (Visa Integrated Payments system) which processes authorization requests and a Base II system which performs clearing and settlement services. Other exemplary payment processing networks may include MasterCard®, Interlink®, Maestro®, Star®, Pulse®, AFFN®, Accel®, CU24®, COOP®, NYCE®, regional networks, etc.

As used herein, an “authorization request message” may refer to a message, or sequence of messages, that requests an issuer of a payment account to authorize a transaction. An authorization request message according to an embodiment of the invention may comply with ISO (International Organization for Standardization) 8583, which is a standard for systems that exchange electronic transactions made by cardholders using payment cards. An authorization request message according to other embodiments may comply with other suitable standards.

As used herein, an “authorization response message” may refer to a message, or sequence of messages, that responds to a merchant's and/or acquirer's request to authorize a transaction. An authorization response message according to an embodiment of the invention may comply with ISO 8583, which, as described above, is a standard for systems that exchange electronic transactions made by cardholders using payment cards. An authorization response message according to other embodiments may comply with other suitable standards.

As used herein, “transaction data” may include data contained in an authorization request and/or authorization response message. For example, transaction data can include a unique transaction identifier, transaction amount (e.g., settlement amount), credit card or payment account number, usage type code (POS-PIN, POS-SIG, ATM, etc.), transaction mode code (e.g., card present, card not present, ATM, bill pay, Internet, telephone, mail order, etc.), transaction type code (purchase, return, deposit, withdrawal, etc.), payment processing network code, merchant code (MVV, DBA, etc.), ATM code, acquirer code, issuer code, authorization category code (e.g., approved, declined, reversed, etc.), cardholder or account holder information (name, date of birth, address, phone number, etc.), card verification value (CVV), issuer identification number (e.g., BIN, etc.), expiration date, loyalty account information, etc.

As used herein, “interchange data” may refer to data describing interchange fees, switch fees, interchange revenue, interchange expense, net interchange, transaction volume, or any other information relating to interchange fees or transaction routing.

As used herein, an “interchange data file” may refer to an electronic file containing interchange data as defined above. An interchange data file may be in the form of a settlement file, a clearing file, a raw data file, or other type of electronic file, and may also contain transaction data as defined above. Exemplary interchange data files may include VSS Raw Data Files, MasterCard 250 Byte Settlement Files, CU24 User Files, and STAR User Files.

As used herein, “enriched transaction data” may include transaction data, as defined above, enriched with interchange data, as also defined above. For example, enriching transaction data for a transaction may refer to adding interchange data to the transaction data for the transaction. In another example, enriching transaction data for a transaction may also include populating data fields for the transaction such as an interchange revenue field, interchange expense field, net interchange field, or other data field.

As used herein, a “report dashboard” may refer to an Internet webpage, server computer, or any other suitable electronic means for electronically presenting a report to an issuer or other entity.

Embodiments of the invention are related to systems and methods for enriching transaction data with interchange data for individual transactions conducted across multiple payment processing networks. The enriched transaction data may be analyzed, and reports may be generated for issuers other entities. The reports may include interchange information (e.g., fee and transaction routing details) at various levels including: transaction, account, cardholder, terminal, merchant store, merchant chain, BIN, payment processing network, etc.

To illustrate, when a user makes a purchase at a merchant using a portable consumer device (e.g., a credit card, debit card, etc.), the user may swipe their device at the merchant's point of sale (POS) terminal which may be connected to a merchant computer. The merchant computer may then transmit an authorization request message to an acquirer computer. The acquirer computer may then route the authorization request message through a payment processing network to a processor system located, in an operational sense, between the payment processing network and an issuer computer. The processor system may then transmit the authorization request message to the issuer computer for authorization of the transaction. After performing authorization processes, the issuer computer may generate and transmit an authorization response message to the processor system. The processor system may then route the authorization response message through the payment processing network for forwarding to the merchant computer. The processor system may extract and normalize transaction data from the authorization messages, and store the transaction data for the transaction in a database. The stored transaction data may include a unique identifier for the transaction and data identifying the payment processing network, the payment account number, the merchant, the ATM, the acquirer, the issuer, the amount of the transaction, the usage type, the transaction mode, the transaction type, the authorization category, etc. This process may be repeated for multiple transactions conducted across multiple payment processing networks, and the processor system can maintain a database storing transaction data for the multiple transactions.

The stored transaction records may not include interchange data for the transactions (e.g., interchange revenue, interchange expense, net interchange, etc.) since the authorization messages may not include such data. However, one or more of the payment processing networks may separately transmit to the processor system an interchange data file (e.g., a settlement file, a clearing file, a raw data file, etc.) including interchange data for each transaction processed by the networks and other transaction data. The interchange data files may be in various formats depending on the originating payment processing network, and the processor system may normalize the interchange data into the same or compatible format as the stored transaction data. After normalization, the processor system may “match” the interchange data with the corresponding transaction data, and enrich the stored transaction data by adding the interchange data to the transaction data for individual transactions. In embodiments of the invention, the processor system may analyze the enriched transaction records and generate reports based upon the analysis. The reports may include interchange fee and transaction routing details at various levels, including on a transactional (i.e. per transaction) basis. The reports may be sent to the account issuers directly or via a report dashboard.

I. Exemplary Systems

Example embodiments are typically implemented in the context of a payment transaction. Therefore, prior to further discussing exemplary systems for enriching transaction data with interchange data for transactions conducted across multiple payment processing networks, a brief description of typical payment processing using a standard payment processing system is presented below.

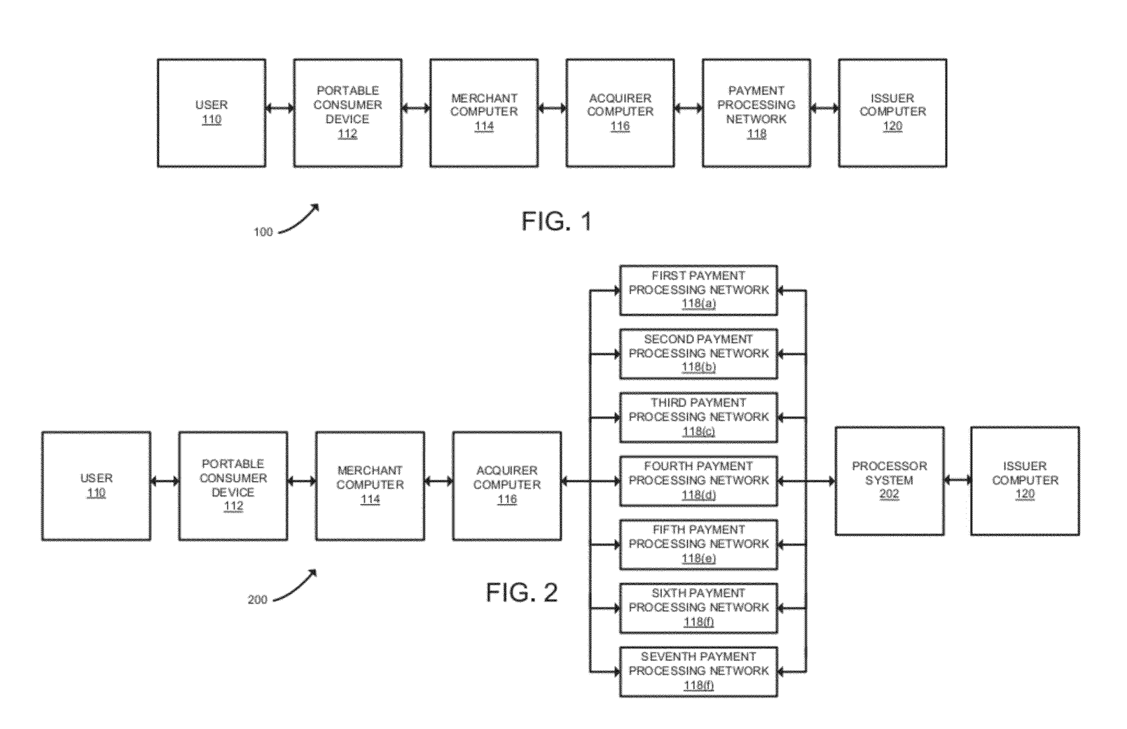

A standard payment processing system 100 as shown in FIG. 1 may include a user 110, a portable consumer device 112, a merchant computer 114, an acquirer computer 116, a payment processing network 118, and an issuer computer 120. In a typical purchase transaction, a user 110 may purchase goods or services at a merchant using a portable consumer device 112 such as a credit card, debit card, prepaid card, etc. The user's portable consumer device 112 may interact with an access device such as a POS terminal at the merchant. For example, the user 110 may take a debit card and swipe it though an appropriate slot in the POS terminal.

Alternatively, the POS terminal may be a contactless reader, and the portable device 112 may be a contactless device such as a contactless card or phone. For example, the user 110 may take a contactless card or a phone and pass it in front of the contactless reader to transmit financial information stored on the device.

An authorization request message may then be transmitted from a merchant computer 114 to an acquirer computer 116. After receiving the authorization request message, the acquirer computer 116 may then transmit the authorization request message to a payment processing network 118. The payment processing network 118 may then forwards the authorization request message to an issuer computer 122 associated with the portable consumer device 112.

After the issuer computer 122 receives the authorization request message, the issuer computer 122 may generate and send an authorization response message to the payment processing network 118 indicating whether or not the transaction was approved. The payment processing network 118 may transmit the authorization response message to the acquirer computer 116 which may then transmit the authorization response message back to the merchant computer 114.

Although the transaction described herein is in the context of a purchase transaction involving a merchant, the transaction may also be an automated teller machine (ATM) transaction. Thus, the merchant computer 114 as shown in FIG. 1 and described herein may alternatively be an ATM.

An exemplary system 200 for transaction processing according to an embodiment of the invention can be seen in FIG. 2. For simplicity of discussion, only one of each component is shown for several of the components. It is to be understood, however, that embodiments of the invention may include more than one of each component. In addition, some embodiments of the invention may include fewer than all of the components shown in FIG. 1. Further, the components in FIG. 1 may communicate via any suitable communication medium such as the Internet using any suitable communication protocol.

FIG. 2 shows a system 200 that may be used in an embodiment of the invention. The system 200 may include a merchant computer 114 and an acquirer computer 116 communicatively coupled to the merchant computer 114. A user 110 may purchase goods or services at a merchant associated with the merchant computer 114 using a portable consumer device 112. The acquirer computer 116 may communicate with a processor system 202 via a plurality of payment processing networks 118(a)-(f). The processor system 202 may be in communication with an issuer computer 120 associated with an issuer of the portable consumer device 112.

As used herein, an “issuer” may be a business entity (e.g., a bank) which maintains financial accounts for the consumer and often issues a portable device such as a credit or debit card to the consumer. A “merchant” may be an entity that engages in transactions and can sell goods or services but as used herein may also include an ATM. An “acquirer” may be a business entity (e.g., a commercial bank) that has a business relationship with a particular merchant or other entity. Some entities may perform both issuer and acquirer functions. Embodiments of the invention encompass such single entity issuer-acquirers.

The user 110 may be an individual, or an organization such as a business that is capable of purchasing goods or services. The user 110 may be a merchant, an employee of the merchant, or any other individual who has access to the portable consumer device 112.

The portable consumer device 112 may be in any suitable form. For example, suitable portable consumer devices may be hand-held and compact so that it can fit into a user's wallet and/or pocket (e.g., pocket-sized). The portable consumer device 112 may include a processor, and memory, input devices, and output devices, operatively coupled to the processor. Specific examples of portable consumer devices include cellular or wireless phones, personal digital assistants (PDAs), pagers, portable computers, smart cards, and the like. The portable consumer device 112 can also be a debit device (e.g., a debit card), credit device (e.g., a credit card), or stored value device (e.g., a pre-paid or stored value card).

The plurality of payment processing networks 118(a)-(f) may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization request messages and in some instances also performs clearing services, and a Base II system which performs clearing services in instances when it is not performed by the VIP system.

The plurality of payment processing networks 118(a)-(f) may also include server computers. A server computer may be a powerful computer or cluster of computers. For example, the server computer may be a large mainframe, a minicomputer cluster, or a group of servers functioning as a unit. In one example, the server computer may be a database server coupled to a Web server. The plurality of payment processing networks 118(a)-(f) may use any suitable wired or wireless network, including the Internet.

The processor system 202 may be an issuer processor or associated with an issuer processor. An issuer processor may include data processing subsystems, networks, and operations used to support and deliver various services such as network gateway, risk management, program management, authorization, exception file, and clearing and settlement servicess. An exemplary issuer processor may include Visa DPS™. As described below, the processor system 202 may comprise a server computer, coupled to a network interface, and one or more information databases, and may provide interchange analysis and reporting services.

The merchant computer 114 may also have, or may receive communications from, an access device that can interact with the portable consumer device 112. The access devices may be in any suitable form. Examples of access devices include point of sale (POS) devices, cellular phones, PDAs, personal computers (PCs), tablet PCs, handheld specialized readers, set-top boxes, electronic cash registers, ATMs, virtual cash registers, kiosks, security systems, access systems, and the like.

If the access device is a point of sale terminal, any suitable point of sale terminal may be used including card or phone readers. The card or phone readers may include any suitable contact or contactless mode of operation. For example, exemplary readers can include RF (radio frequency) antennas, magnetic stripe readers, etc. to interact with the portable consumer device 112.

In a purchase transaction, the user 110 may purchase goods or services at the merchant associated with the merchant computer 114 using the portable consumer device 112 such as a credit card or mobile phone. The consumer's portable consumer device 1152 can interact with an access device such as a POS (point of sale) terminal communicatively coupled to the merchant computer 114. For example, the user 110 may swipe their credit card through a POS terminal or, in another embodiment, may take a wireless phone or card and pass it near a contactless reader of a POS terminal.

An authorization request message may then transmitted by the merchant computer 114 to the acquirer computer 116. After receiving the authorization request message, the acquire computer 116 may then transmit the authorization request message to one of the plurality of payment processing networks 118(a)-(d). The one of the plurality of payment processing networks 118(a)-(d) may then transmit the authorization request message to the processor system 202. The processor system 202 may then transmit the authorization request message to the issuer computer 120 associated with the issuer of the portable consumer device 112.

After receiving the authorization request message, the issuer computer 120 may perform a number of authorization processes and send an authorization response message to the processor system 202 indicating whether the transaction is authorized (or not authorized). The processor system 202 may transmit the authorization response message to the one of the plurality of payment processing networks 118(a)-(f) for transmission to the acquirer computer 116. The acquirer computer 116 may then transmit the authorization response message back to the merchant computer 114.

After the merchant computer 114 receives the authorization response message, the access device communicatively connected to the merchant computer 114 may then provide the authorization response message to the user 110. The authorization response message may be displayed by the POS terminal, or may be printed out on a receipt.

Using transaction data contained in the authorization request and response messages, the processor system 202 may store transaction data for the transaction. The above purchase transaction can be repeated, and purchase transactions can be conducted by other users, merchants, acquirers, and issuers utilizing each of the plurality of payment processing networks 118(a)-(f). Thus, the processor system 202 may store transaction data for a plurality of transactions processed by the plurality of payment processing networks 118(a)-(f). The components and functionalities of the processor system 202 according to various embodiments of the invention are described in further detail below.

At the end of the day, a normal clearing and settlement process may be conducted by the plurality of payment processing networks 118(a)-(f). A clearing process can be a process of exchanging financial details between an acquirer and an issuer to facilitate posting to a consumer's account and reconciliation of the consumer's settlement position. A settlement process can be a process of transferring funds between an acquirer and issuer. In some embodiments, clearing and settlement can occur simultaneously.

In some embodiments, clearing data files are created during the clearing process, and settlement data files are created during the settlement process. These clearing and settlement data files may contain interchange data. Interchange data may include data describing interchange fees, switch fees, interchange revenue, interchange expense, net interchange, or any other information relating to interchange fees or transaction routing details. The clearing and/or settlement files containing interchange data may be transmitted to the processor system 202 as an interchange data file by one or more of the plurality of payment processing networks 118(a)-(f), the issuer computer 120, or other entity. Alternatively, interchange data may be transmitted to the processor system 202 by one or more of the plurality of payment processing networks 118(a)-(f) separate from the settlement and clearing processes. For example, one or more of the plurality of payment processing networks 118(a)-(f) may transmit an interchange data file to the processor system 202 on a periodic basis (e.g., daily).

II. PROCESSOR SYSTEM

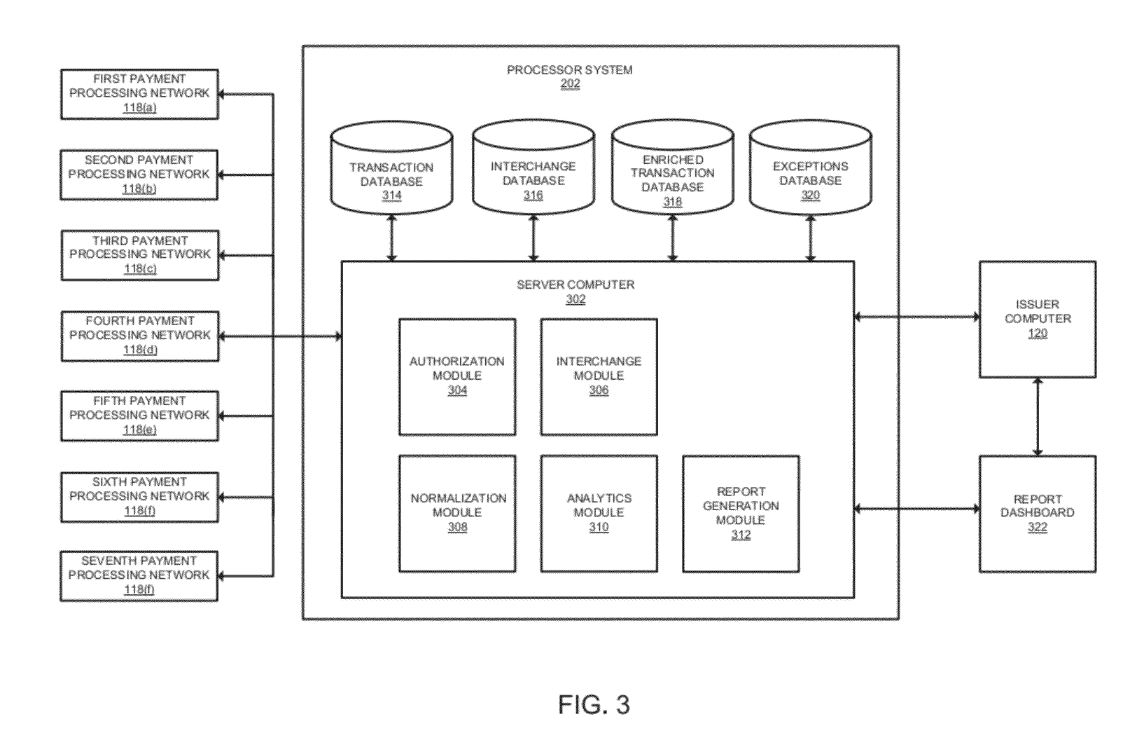

FIG. 3 is a block diagram showing the components of the processor system 202 according to an embodiment of the invention. As shown in FIG. 3, the processor system 202 may include a server computer 302 comprising an authorization module 304, an interchange module 306, a normalization module 308, an analytics module 310, and a report generation module 312. The various modules may be embodied by computer code residing on computer readable media. The report generation module 312 may be in communication with a report dashboard 322, and the server computer 302 may be in communication with the issuer computer 120.

The server computer 302 may be operatively coupled to one or more databases, including a transaction database 314, an interchange database 316, an enriched transaction database 318, and an exceptions database 320.

The authorization module 304 may perform a number of functions related to receiving and forwarding authorization request and authorization response messages. Upon receiving an authorization request message from one of the plurality of payment processing networks 118(a)-(f), the authorization module 304 may forward the authorization request message to the issuer computer 120. Upon receiving an authorization response message from the issuer computer 120, the authorization module 304 may transmit the authorization response message to one of the plurality of payment processing networks 118(a)-(f). The authorization module 304 may also extract transaction data from authorization request and response messages and transmit the extracted data to the transaction database 316 for storage. In some embodiments, the authorization module 304 may transmit the extracted transaction data to the normalization module 308 for normalization prior to storing the transaction data in the transaction database 314 by the authorization module 304 or the normalization module 308.

The interchange module 306 may perform a number of functions related to receiving, processing, and transmitting interchange data. For example, upon receiving an interchange data file from one of the plurality of payment processing networks 118(a)-(f), the interchange module 306 may extract the interchange data from the interchange data file and transmit the interchange data to the interchange database 316 for storage. The interchange module 306 may modify extracted interchange data prior to transmitting to the interchange database 318, and may also generate interchange data (e.g., for transactions routed across networks that do not transmit an interchange data file) for storage in the interchange database 318. In embodiments of the invention, the interchange module 306 may transmit the extracted interchange data to the normalization module 308 for normalization prior to storing the interchange data in the interchange database 316 by the interchange module 306 or the normalization module 308. The interchange module 306 may also enrich the transaction data stored in the transaction database 316 with the interchange data stored in the interchange database 318, and store the enriched transaction data in the enriched transaction database 318. The enriched transaction data may include additional fields such as (interchange revenue, interchange expense, net interchange, transaction volume, etc.) Before, during, or after enrichment, the interchange module 306 may analyze one or more fields in the transaction data and interchange data to determine whether an interchange value included in the interchange data is associated with an interchange expense or revenue for the issuer of the portable consumer device 112.

The normalization module 308 may perform a number of functions relating to the normalization and reformatting of transaction data and interchange data. For example, the normalization module 308 may normalize the transaction data extracted from authorization request and response messages by the authorization module 304 before storing in the transaction database 314. Thus, the transaction data may be stored in a format suitable for analysis and reporting. The normalization module 308 may also normalize the interchange data extracted from the interchange data files received by the interchange module 306. As described herein, the interchange data contained in the interchange data files provided by the plurality of payment processing networks 118(a)-(f) may be in various formats depending on the originating payment processing network. The normalization module 308 may determine the data format of received interchange data files and, if necessary, convert the interchange data files into a data format compatible with (or the same as) the data format of the transaction data stored in the transaction database 314. A received interchange data file may also include more, less, or different data fields than the transaction records stored in the transaction database 314, and may include different formats for unique transaction identifiers, payment processing network codes, usage type codes, transaction type codes, merchant codes, ATM codes, acquirer codes, issuer codes, etc than the corresponding transaction data stored in the transaction database 314. The normalization module 308 may normalize the interchange data files received from the plurality of payment processing networks 118(a)-(f) so that there is consistency of data, fields, and identifiers amongst the transaction data stored in the transaction database 314 and the interchange data stored in the interchange database 316.

The analytics module 310 may perform a number of functions relating to the analysis of enriched transaction data stored in the enriched transaction database 318. For example, the analytics module 310 may parse and/or aggregate the enriched data for individual transactions such that the enriched data can be transmitted or reported to the issuer in a useful and coherent format. The analytics module 310 may analyze the enriched transaction data at various levels of detail such as the transaction level, the account level, the cardholder level, the terminal level, the merchant store level, the merchant chain level, the BIN level, the payment processing network level, etc. The analytics module 310 may also analyze the enriched transaction data to determine trends associated with interchange revenue, interchange expense, net interchange, transaction routing, etc. The analytics module 310 may also generate exceptions data for storage in the exceptions database 320. For example, the analytics module 310 may analyze the enriched transaction data to determine if various stored criteria are satisfied. The stored criteria may include rules regarding maximum interchange values, for example, for individual transactions. If the analytics module 310 determines that a transaction violate one or more of the rules, exceptions data identifying a potential non-compliant transaction may be stored by the analytics module 310 in the exceptions database 320.

The report generation module 312 may perform a number of functions relating to the generation of reports. After the analytics module 310 analyzes the enriched transaction data stored in the enriched transaction database 318, the report generation module 312 may compile the analyzed data and generate a report based upon the analysis. The report may include interchange information such as interchange revenue, interchange expense, net interchange, transaction routing, and trends at various levels including at the transaction level, account level, cardholder level, terminal level, merchant store level, merchant chain level, BIN level, payment processing network level, etc. Reports can be transmitted by the report generation module 312 to the issuer computer 120 directly or via the report dashboard 322.

The transaction database 314 may be used by the server computer 302 to store transaction data. The source of the transaction data may be the various authorization request and response messages routed through the processor system 202 by the issuer computer 120 and the plurality of payment processing networks 118(a)-(f). The transaction data may be stored in the transaction database 314 by the authorization module 304, normalization module 306, or other component described herein. In embodiments of the invention, the transaction data may be stored in the transaction database 314 in the form of transaction data tables.

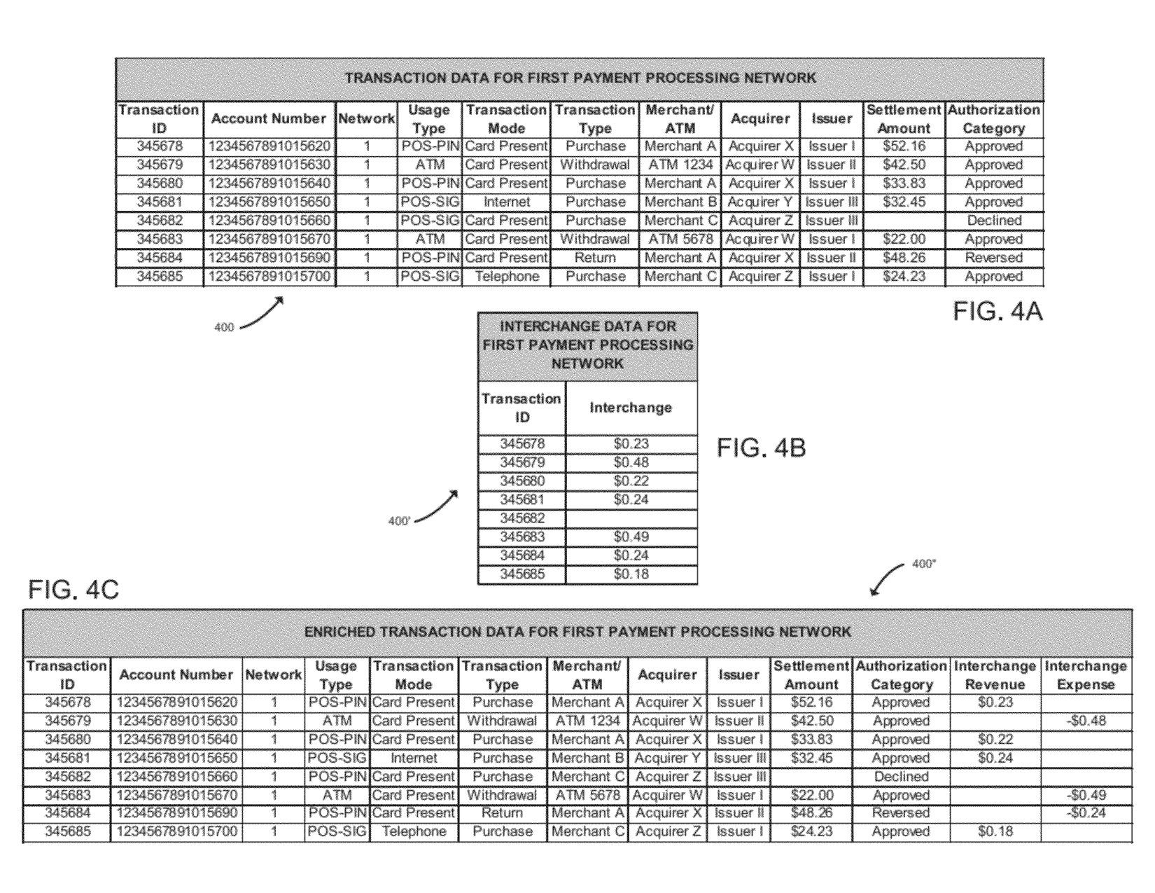

FIG. 4A shows a transaction data table 400 for the first payment processing network 118(a) stored in the transaction database 314 according to an embodiment of the invention. As seen in FIG. 4A, the transaction data table 400 may include various fields for each transaction including a transaction ID field, an account number field, a payment processing network field, a usage type field, a transaction mode field, a transaction type field, a merchant/ATM field, an acquirer field, an issuer field, a settlement amount field, and an authorization category field. Any suitable combination of the fields in FIG. 4A may be used in transaction data table 400, and more, less, or different fields can be used according to embodiments of the invention. For each stored transaction, the transaction ID field may include a unique transaction identifier (e.g., a unique alphanumeric code assigned to the transaction by the payment processing network, merchant, acquirer, issuer, processor system 202, or other entity). The account number field may include a financial account number (e.g., a credit, debit, or prepaid account number), and the payment processing network field may include a payment processing network code (e.g., an alphanumeric code identifying the payment network that processed the transaction). The usage type field may include a usage type code (e.g., an alphanumeric code identifying the transaction as being conducted at the point of sale using a PIN code, at the point of sale using a signature, at an ATM, etc.). the transaction mode field may include a transaction mode code (e.g., an alphanumeric code identifying the transaction mode as being a “card present” e.g., face-to-face transaction, a “card not present” transaction, an ATM transaction, an Internet transaction, a telephone transaction, a mail order transaction, a bill pay transaction, etc.), the transaction type field may include a transaction type code (e.g., an alphanumeric code identifying the type of transaction as being a purchase, return, withdrawal, deposit, etc.). The merchant/ATM field may include a merchant or ATM code (e.g., an alphanumeric code identifying the merchant terminal, the merchant store, the merchant chain, the ATM, etc. associated with the transaction). In some embodiments of the inventions, the merchant code can be a Merchant Verification Value (MW) or a Merchant Doing Business As (DBA) code. The acquirer field may include an acquirer code (e.g., an alphanumeric code identifying the acquirer associated with the transaction). The issuer field may include an issuer code (e.g., an alphanumeric code identifying the issuer of the account used in the transaction). The settlement amount field may include a purchase amount associated with the transaction, and the authorization category field may include a authorization category code (e.g., a code identifying the transaction as approved, declined, reversed, etc.).

The interchange database 316 may be used by the server computer 302 to store interchange data. As described above, interchange data files may be received from the plurality of payment processing networks 118(a)-(f). The interchange data contained in the interchange data files may be extracted by the interchange module 306, normalized by the normalization module 308, and stored in the interchange database 316 by the interchange module 306 or the normalization module 308. The interchange data may be stored in the interchange database 316 in the form of interchange data tables.

FIG. 4B shows an interchange data table 400′ for the first payment processing network 118(a) stored in the interchange database 316 according to an embodiment of the invention. As seen in FIG. 4B, the interchange data table 400′ may include various fields for transactions conducted across the first payment processing network 118(a). For example, the interchange data table 400′ may include a transaction ID field and an interchange field. The transaction ID field may include a unique transaction identifier for each stored transaction. The interchange field may include an interchange value for the transaction. In embodiments of the invention, additional processing may by the server computer 302 may be needed to determine whether the interchange value included in the interchange data is associated with an interchange revenue or expense for the issuer associated with the portable consumer device 112. In embodiments of the invention, the interchange data received from one or more of the plurality of payment processing networks 118(a)-(f) may include an indication that the interchange value should be associated with an interchange revenue or expense for the issuer. Any other suitable fields may be included in interchange data table 400′ such as an account number field including financial account numbers, a payment processing network field including payment processing network codes, a usage type field including usage type codes, a transaction mode field including transaction mode codes, a transaction type field including transaction type codes, a merchant/ATM field including merchant codes and ATM codes, an acquirer field including acquirer codes, an issuer field including issuer codes, a settlement amount field including purchase amounts, an authorization category field including authorization category codes, etc.

The enriched transaction database 318 may be used by the server computer 302 to store transaction data enriched by the interchange module 306. As described above, transaction data may be extracted by the authorization module 304 from the authorization messages, normalized by the interchange module 306, and stored in the transaction database 314. As also explained above, interchange data files may be received from the plurality of payment processing networks 118(a)-(f). The interchange data contained in the interchange data files may be extracted by the interchange module 306, normalized by the normalization module 308, and stored in the interchange database 316. The interchange module 306 may enrich the stored transaction data with the stored interchange data, and store the enriched transaction data in the enriched transaction database 318. The enriched transaction data may be stored in the enriched transaction database 318 in the form of enriched transaction data tables.

FIG. 4C shows an enriched transaction data table 400″ for the first payment processing network 118(a) stored in the enriched transaction database 318 according to an embodiment of the invention. Upon receipt of an interchange data file from the first payment processing network 118(a), and extraction of the interchange data to create interchange data table 400′ in interchange database 316, the interchange module 306 may enrich the data from transaction data table 400 with the data from interchange data table 400′ to create enriched transaction data table 400″ in enriched transaction database 318. As seen in FIG. 4C, in enriched transaction data table 400″, interchange revenue and interchange expense fields may be created and populated for one or more of the stored transactions.

III. Exemplary Methods

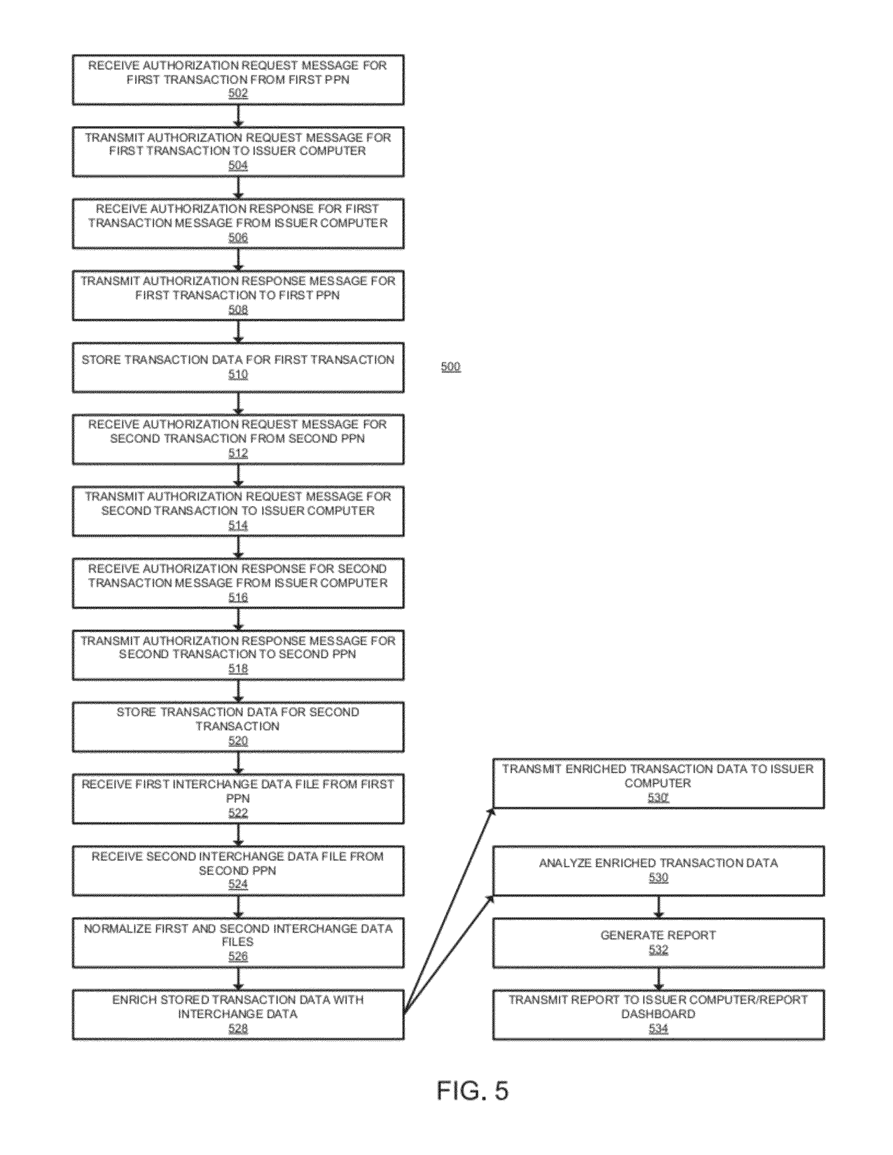

FIG. 5 is a flow diagram showing a method 500 of enriching transaction data with interchange data for transactions conducted across multiple payment processing networks. The steps performed in the method 500 can be performed by the server computer 302 or by any other suitable component of the processor system 202. In alternative embodiments, one or more of the steps described herein may be performed by any other suitable computer system, such as the issuer computer 120, or a server computer included in one or more the plurality of payment processing networks 118(a)-(f).

The method 500 may begin by receiving an authorization request message for a first transaction from the first payment processing network 118(a). This is shown as step 502. The authorization request message may be received by the server computer 302 and processed by the authorization module 304. Further, the authorization request message for the first transaction may include transaction data such as a unique transaction identifier, an account number, a payment processing network code, a usage type code, a transaction mode code, a transaction type code, a merchant code, an ATM code, an acquirer code, an issuer code, a transaction amount, and other transaction data for the first transaction.

After receiving the authorization request message for the first transaction, the authorization request message may be transmitted to the issuer computer 120 in step 504. For example, the server computer 302 may utilize the authorization module 304 to transmit the authorization request message to the issuer computer 120.

At step 506, an authorization response message for the first transaction may be received from the issuer computer 120. The authorization response message may be received by the server computer 302 and processed by the authorization module 304. The authorization response message for the first transaction may include transaction data such as the unique transaction identifier, the account number, the payment processing network code, the usage type code, the transaction mode code, the transaction type code, the merchant code, the ATM code, the acquirer code, the issuer code, the transaction amount, an authorization category code, and other transaction data for the first transaction.

After receiving the authorization response message for the first transaction, the authorization response message may be transmitted to the first payment processing network 118(a). This is shown as step 508. For example, the server computer 302 may utilize the authorization module 120 to transmit the authorization response message to the first payment processing network 118(a).

At step 510, the transaction data for the first transaction may be stored. For example, the server computer 302 may utilize the authorization module 304 to extract the transaction data from the authorization messages for the first transaction and store the transaction data for the first transaction in a data table in the transaction database 314. In embodiments of the invention, the transaction data for the first transaction may be normalized by the normalization module 308 prior to storing in the transaction database 314.

At step 510, an authorization request message for a second transaction may be received from the second payment processing network 118(b). The authorization request message for the second transaction may be received by the server computer 302 and processed by the authorization module 304. Further, the authorization request message for the second transaction may include transaction data such as a unique transaction identifier, an account number, a payment processing network code, a usage type code, a transaction mode code, a transaction type code, a merchant code, an ATM code, an acquirer code, an issuer code, a transaction amount, and other transaction data for the second transaction.

After receiving the authorization request message for the second transaction, the authorization request message may be transmitted to the issuer computer 120 in step 514. For example, the server computer 302 may utilize the authorization module 304 to transmit the authorization request message for the second transaction to the issuer computer 120.

At step 516, an authorization response message for the second transaction may be received from the issuer computer 120. The authorization response message for the second transaction may be received by the server computer 302 and processed by the authorization module 304. The authorization response message for the second transaction may include transaction data such as the unique transaction identifier, the account number, the payment processing network code, the usage type code, the transaction type code, the merchant code, the ATM code, the acquirer code, the issuer code, the transaction amount, an approval or decline code, an authorization category code, and other transaction data for the second transaction.

After receiving the authorization response message for the second transaction, the authorization response message may be transmitted to the second payment processing network 118(b). This is shown as step 518. For example, the server computer 302 may utilize the authorization module 120 to transmit the authorization response message for the second transaction to the second payment processing network 118(b).

At step 520, the transaction data for the second transaction may be stored. For example, the server computer 302 may utilize the authorization module 304 to extract the transaction data from the authorization messages for the second transaction and store the transaction data for the second transaction in a transaction data table in the transaction database 314. In embodiments of the invention, the transaction data for the second transaction may be normalized by the normalization module 308 prior to storing in the transaction database 314.

At step 522, a first interchange data file including interchange data for the first transaction may be received from the first payment processing network 118(a). For example, the interchange module 306 in the server computer 302 may receive the interchange data file for the first transaction, extract the interchange data, and store the interchange data for the first transaction in an interchange data table in the interchange database 316. The interchange data for the first transaction may include the unique transaction identifier and an interchange value for the first transaction. In embodiments of the invention, the interchange data for the first transaction may include an interchange revenue value, an interchange expense value, a net interchange value, or other interchange data. The interchange data file for the first transaction may also include the account number, the payment processing network code, the usage type code, the transaction mode code, the transaction type code, the merchant code, the ATM code, the acquirer code, the issuer code, the transaction amount, and the authorization category code for the first transaction.

At step 524, a second interchange data file including interchange data for the second transaction may be received from the second payment processing network 118(b). For example, the interchange module 306 in the server computer 302 may receive the interchange data file for the second transaction, extract the interchange data, and store the interchange data for the second transaction in an interchange data table in the interchange database 316. The interchange data for the second transaction may include the unique transaction identifier and an interchange value for the second transaction. In embodiments of the invention, the interchange data for the second transaction may include an interchange revenue value, an interchange expense value, a net interchange value, or other interchange data. The interchange data file for the second transaction may also include the account number, the payment processing network code, the usage type code, the transaction mode code, the transaction type code, the merchant code, the ATM code, the acquirer code, the issuer code, the transaction amount, and the authorization category code for the second transaction.

The first and second interchange data files may be normalized before, during, or after storing the interchange data for the first and second transactions in the interchange database 316. This is shown as step 526. For example, the server computer 302 may use the normalization module 308 to normalize and/or reformat the interchange data included in the first and second interchange data files. As explained above, transaction data may be stored in the transaction database 314 by the authorization module 304 and/or normalization module 308 in a particular format suitable for analyzing and reporting enriched transaction data. However, interchange data files received from the plurality of payment processing networks 118(a)-(f) may be in various formats. The normalization module 308 may determine the data format of received interchange data files and, if necessary, convert the interchange data files into a data format compatible with (or the same as) the data format of the transaction data stored in the transaction database 314. A received interchange data file may also include more, less, or different data fields than the transaction records stored in the transaction database 314, and may include different formats for unique transaction identifiers, payment processing network codes, usage type codes, transaction mode codes, transaction type codes, merchant codes, ATM codes, acquirer codes, issuer codes, authorization category codes, etc. than the corresponding transaction data stored in the transaction database 314. The normalization module 308 may normalize the interchange data files received from the first and second payment processing networks 118(a), 118(b) so that there is consistency of data, fields, and identifiers between the transaction data stored in the transaction database 314 and the interchange data stored in the interchange database 316.

At step 524, the transaction data for the first and second transactions can be enriched with the interchange data for the first and second transactions. For example, the interchange module 306 may “match” the transaction data stored in the transaction database 314 for the first and second transactions with the interchange data stored in the interchange database 316 for the first and second transactions. The data matching can be accomplished in a number of ways according to embodiments of the invention. For example, the unique transaction identifiers for the first and second transactions may be included in both the transaction data stored in the transaction database 314 and the interchange data stored in the interchange database 316. After identifying the matching unique transaction identifiers, the interchange module 306 may add all or part of the interchange data for the first and second transactions to the transaction data for the first and second transactions and store the enriched transaction data for the first and second transactions in the enriched transaction database 318. For example, the interchange module 306 may enrich the stored transaction data for the first transaction by adding an interchange revenue value and/or an interchange expense value to the transaction data for the first transaction and store the enriched transaction data for the first transaction in the enriched transaction database 318. The interchange module 306 may repeat the same process for the second transaction by adding an interchange revenue value and/or an interchange expense value to the transaction data for the second transaction and store the enriched transaction data for the second transaction in the enriched transaction database 318. In some embodiments, the interchange module may populate an interchange revenue and/or interchange expense field for the first and second transactions in an enriched transaction data table stored in the enriched transaction database 318.

In some embodiments, any of the account number, the payment processing network code, the usage type code, the transaction mode code, the transaction type code, the merchant code, the ATM code, the acquirer code, the issuer code, the transaction amount, the authorization category code, or other transaction data for the first and second transactions may be utilized by the interchange module 306 to match the interchange data with the transaction data for the first and second transactions. For example, if the interchange data for the first or second transaction includes a different unique transaction identifier (e.g., due to a different format used by the first or second payment processing networks 118(a), 118(b)) than that included in the stored transaction data for the transaction, the interchange module 306 may compare other fields in the stored transaction data with corresponding fields in the interchange data to determine a match. Transaction dates may also be included in the interchange data and transaction data for the first and second transactions, and may also be used to determine a match.

In some embodiments, additional processing by the server computer 302 may be needed to determine if an interchange value included in the interchange data for the first or second transactions is associated with an interchange revenue or expense for the issuer associated with the portable consumer device 112. For example, if the usage type code for the transaction indicates an ATM transaction, the interchange module 306 may determine that the interchange value included in the interchange data for the transaction is an interchange expense value for the issuer and may populate an interchange expense field in the enriched transaction database 318 accordingly for the transaction. In another example, if the usage type code and transaction type code for the transaction indicate a purchase transaction, the interchange module 306 may determine that the interchange value included in the interchange data for the transaction is an interchange revenue value for the issuer and may populate an interchange revenue field in the enriched transaction database 318 accordingly for the transaction. In another example, if the transaction type code for the transaction indicates a return transaction (e.g., that the user 110 has returned an item previously purchased from the merchant), the interchange module 306 may determine that the interchange value included in the interchange data for the transaction is an interchange expense value for the issuer and may populate an interchange expense field in the enriched transaction database 318 accordingly for the transaction.

In embodiments of the invention, the interchange module 306 may perform additional calculations before, during, or after enrichment of the transaction data for the first and second transactions. For example, the interchange values included in the interchange data files may include “switch fees.” A switch fee is typically a fee paid to a payment network for processing a transaction. To determine the interchange revenue or expense value for the issuer when the interchange data file includes a switch fee, the switch fee may first be subtracted from the interchange value included in the interchange data.

In embodiments of the invention, the interchange revenue or expense value for the first or second transaction may be estimated in the absence of interchange data files being received from the first and second payment processing networks 118(a), 118(b). The interchange module 306 may estimate the interchange revenue and/or expense values for the transaction in a number of different ways. Interchange rates are typically determined by a number of factors including payment card brand, the geographic region in which the transaction takes place, the type of credit or debit card, the type and size (e.g., sales and transaction volume) of the accepting merchant, and the type of transaction (e.g., card present, Internet, telephone, mail order, bill pay, etc.). Merchants are often categorized into “tiers” based on one or more of these factors, and the interchange rate charged for a given transaction may depend on what tier the merchant is in. Further, payment processing networks typically publish interchange rate schedules. In embodiments of the invention, the interchange database 316 (or other database communicatively coupled to the server computer 202) may store the published interchange rate schedules for one or more of the plurality of payment processing networks 118(a)-(f). The interchange module 306 may compare the transaction data for the transaction (e.g., the merchant code, transaction type, etc.) with the published interchange rates for the first payment processing network to determine a merchant tier and perform one or more calculations to estimate the interchange revenue or interchange expense value for the transaction. The interchange module 306 may enrich the transaction data for the first or second transaction with the estimated interchange data and store the enriched transaction data in the enriched transaction database 318.

Upon enriching the stored transaction data for the first and second transactions, the method can move to step 530 or step 530′. At step 530′, the enriched transaction data for the first and second transactions may be transmitted by the processor system 202 to the issuer computer 120 using any suitable electronic means such as the Internet, e-mail, the communications channel used to exchange authorization messages, etc. Alternatively, the method can move to step 530.

At step 530, the enriched transaction data for the first and second transactions may be analyzed. For example, the analytics module 310 may parse and/or aggregate the enriched transaction data for first and second transactions stored in the enriched transaction database 118. The analytics module 310 may analyze the enriched transaction data for the first and second transactions at various levels of detail such as the transaction level, the account level, the cardholder level, the terminal level, the merchant store level, the merchant chain level, the BIN level, the payment processing network level, etc. The analytics module 310 may also analyze the enriched transaction data for the first and second transactions to determine trends associated with interchange revenue, interchange expense, net interchange, transaction routing, etc.

At step 530, exceptions data may also be generated. For example, the analytics module 310 may analyze the enriched transaction data for the first and second transactions to generate exceptions data for storage in the exceptions database 320. In embodiments of invention, the analytics module 310 may analyze the enriched transaction data for the first and second transactions to determine if various stored criteria are satisfied. The stored criteria may include rules regarding maximum interchange values for individual transactions. If the analytics module 310 determines that the first or second transaction violates one or more of the rules, exceptions data indicating a potentially non-compliant transaction may be stored by the analytics module 310 in the exceptions database 320.

After the enriched transaction data for the first and second transactions has been analyzed, reports maybe generated based upon the analysis. This is shown as step 532. In embodiments of the invention, the report generation module 312 may compile the analyzed data and generate one or more reports based upon the analysis. The report may include interchange information such as interchange revenue, interchange expense, net interchange, transaction routing, and trends at various levels, including the transaction level, account level, cardholder level, terminal level, merchant store level, merchant chain level, BIN level, payment processing network level, etc. Reports may be transmitted by the report generation module 312 to the issuer computer 120 directly or via the report dashboard 322 at step 534.

In embodiments of the invention, method 500 may be repeated for a plurality of transactions conducted across the plurality of payment processing networks 118(a)-(f). The plurality of transactions may include a plurality of users, portable consumer devices, merchants, acquirers, and issuers. Transaction data for the plurality of transactions may be stored, and this transaction data may be enriched with interchange data for the plurality of transactions. The enriched transaction data for the plurality of transactions may be analyzed and one or more reports may be generated and transmitted to one or more of the plurality of issuers.

IV. Exemplary Reports

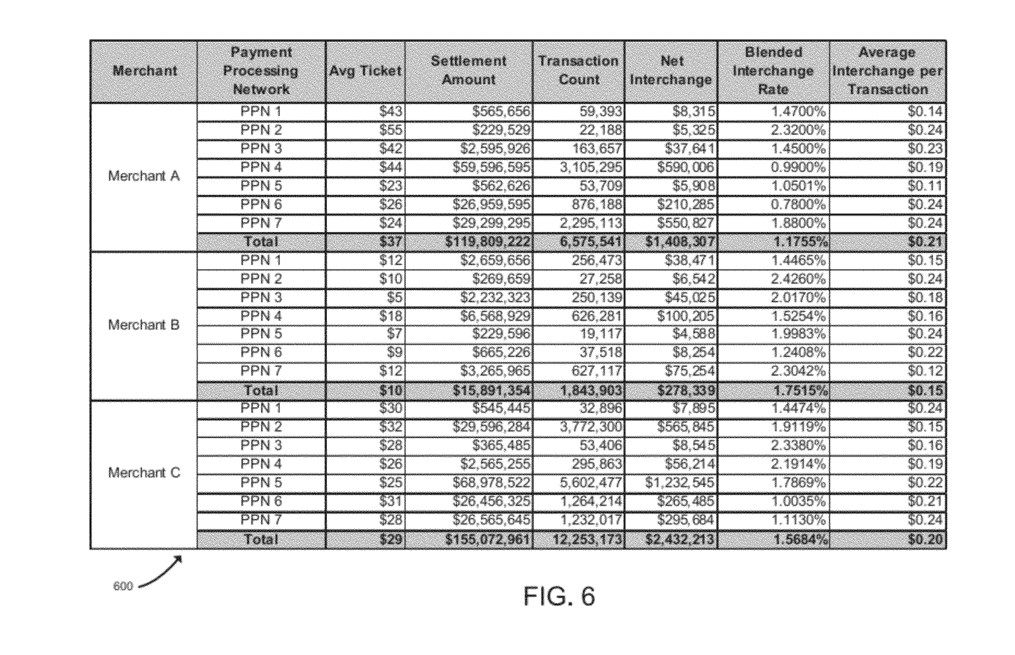

FIG. 6 shows a merchant level interchange report 600 according to an embodiment of the invention. As shown in FIG. 6, the merchant level interchange report 600 may provide interchange information to an issuer for specific merchants (e.g., Merchants A, B, and C). The merchant level interchange report 600 may include interchange information over a selected time period (e.g., daily, monthly, etc.) for the issuer, and may include various columns including: “merchant,” “payment processing network,” “average ticket,” “settlement amount,” “transaction count,” “net interchange,” “blended interchange rate,” and “average interchange per transaction.” In embodiments of the invention, the merchant level interchange report 600 may include more, less, or different columns of interchange information. The “merchant” column may include merchants identified by merchant name, merchant store, merchant chain, merchant code (e.g., a MVV), etc. For each merchant listed in the merchant column, the “payment processing network” column may include one or more payment processing networks identified by network name, network code, etc. For each payment processing network listed: the “average ticket” column may include an average ticket (e.g., average purchase) value for transactions with the merchant and processed by the network, the “settlement amount” column may include a total settlement value (e.g., aggregate total value of all approved purchases) with the merchant and processed by the network, the “transaction count” column may include the total number of transactions with the merchant and processed by the network (e.g., transaction volume), the “net interchange” column may include the net interchange revenue for transactions with the merchant and processed by the network (e.g., total interchange expenses subtracted from total interchange revenue), the “blended interchange” column may include the total blended interchange for transactions with the merchant and processed by the network (e.g., net interchange divided by settlement amount), and the “average interchange per transaction” column may include average interchange revenue per transaction with the merchant and processed by the network (e.g., net interchange divided by transaction count). Total values for each merchant for one or more of the columns may also be included in the merchant level interchange report 600.

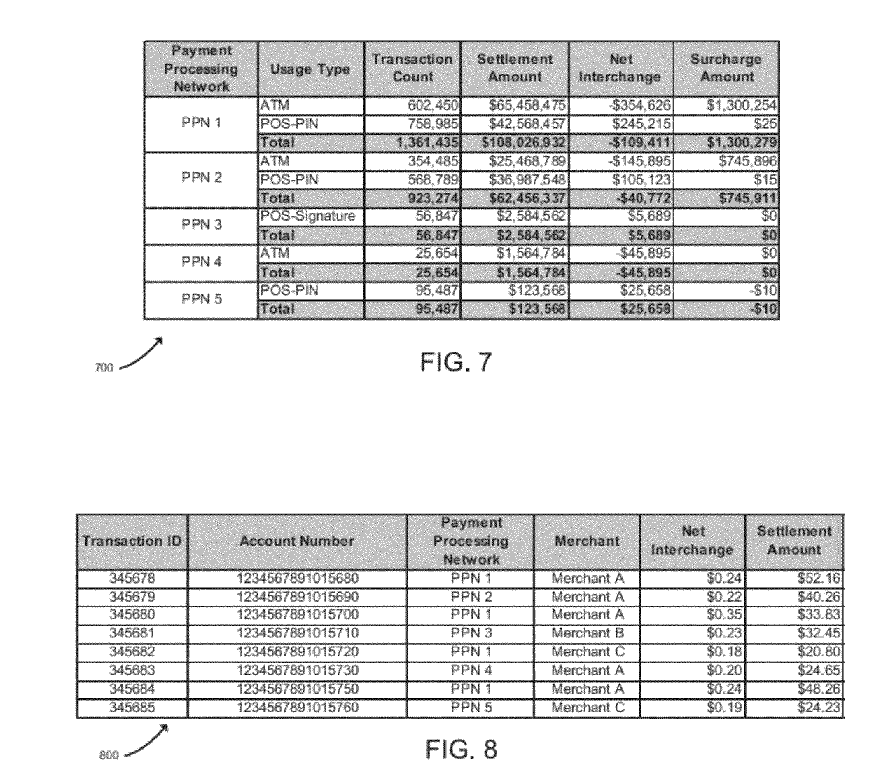

FIG. 7 shows a network level interchange report 700 according to an embodiment of the invention. As shown in FIG. 7, the network level interchange report 700 may provide interchange information to an issuer for specific payment processing networks (e.g., Networks 1 to 5). The network level interchange report 700 may include interchange information over a selected time period (e.g., daily, monthly, etc.) for the issuer, and may include various columns including: “payment processing network,” “usage type,” “transaction count,” “settlement amount,” “net interchange,” and “surcharge amount.” In embodiments of the invention, the network level interchange report 700 may include more, less, or different columns of interchange information. The “payment processing network” column may include one or more payment processing networks identified by network name, network code, etc. For each payment processing network listed, the “usage type” column may include an indicator of various categories of usage type such as ATM (e.g., ATM transactions where an interchange fee may be paid by the issuer to acquirer), POS-PIN (e.g., transactions where a PIN code is entered by the user), POS-signature (e.g., transactions where a signature is provided by the user), etc. For each usage type listed: the “transaction count” column may include a total number of transaction of the type and processed by the network, the “settlement amount” column may include a total settlement (e.g., aggregate total of all approved purchases) value of the type and processed by the network, the “net interchange” column may include the net interchange revenue (or expense) for transactions of the type and processed by the network (e.g., total interchange expense subtracted from total interchange revenue), and the “surcharge amount” column may include the total surcharge value (e.g., additional fees charged to users for ATM withdrawals, loyalty programs, corporate accounts, etc.) for transactions of the type and processed by the network. Total values for each payment processing network for one or more of the columns may also be included in the network level interchange report 700

FIG. 8 shows an transaction level interchange report 800 according to an embodiment of the invention. As shown in FIG. 8, the transaction level interchange report may provide interchange information to an issuer for individual transactions. The transaction level interchange report 800 may include various columns including: “transaction ID,” “account number,” “payment processing network,” “merchant,” “net interchange,” and “settlement amount.” In embodiments of the invention, the transaction level interchange report 800 may include more, less, or different columns of interchange information. The “transaction ID” column may include unique transaction identifiers (e.g., unique alphanumeric codes assigned to the transactions by the payment processing network, merchant, acquirer, issuer, processor system 202, or other entity). For each transaction: the “payment processing network” column may include a payment processing networks identified by network name, network code, etc. that processed the transaction, the “merchant” column may include a merchant identified by merchant name, merchant store, merchant chain, merchant code (e.g., a MVV), etc. for the transaction, the “net interchange” column may include the net interchange revenue (or expense) for the transaction, and the “settlement amount” column may include the total purchase amount for the transaction.

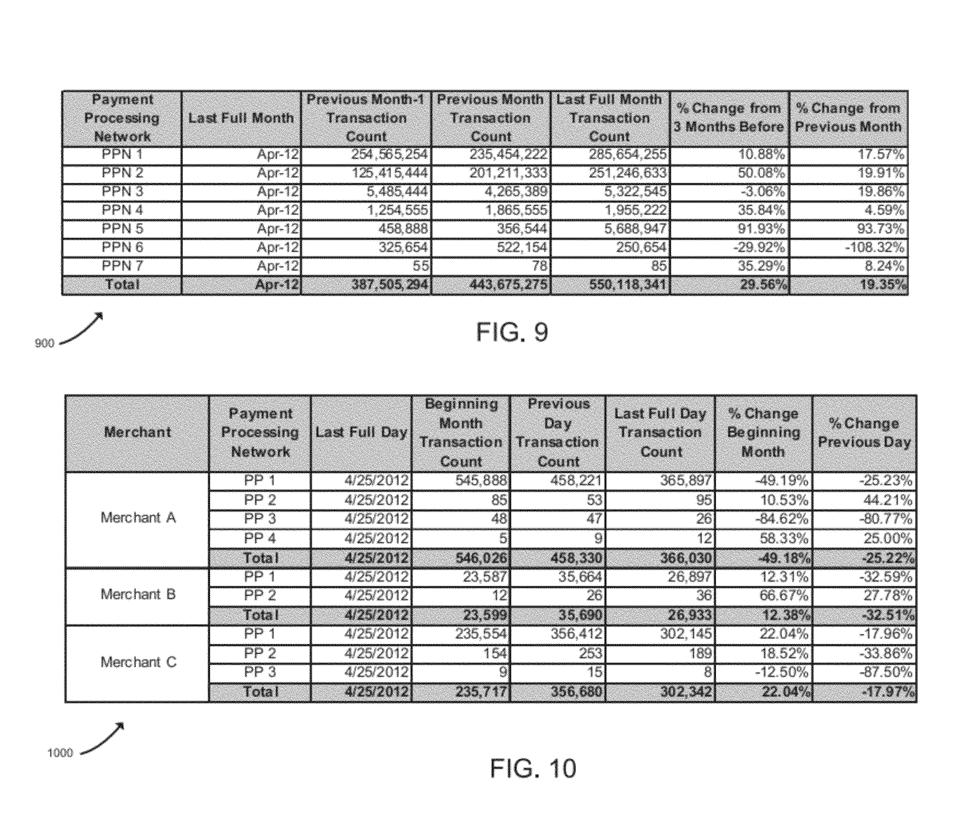

FIG. 9 shows a network level volume report 900 according to an embodiment of the invention. As shown in FIG. 9, the network level volume report 900 may provide interchange information (e.g., network routing trends) to an issuer for specific payment processing networks (e.g., Networks 1 to 7). The network level volume report 900 may include various columns including: “payment processing network,” “last full month,” “previous month−1 transaction count,” “previous month transaction count,” “last full month transaction count,” “% change from 3 months before,” and “% change from previous month”. In embodiments of the invention, the network level volume report 900 may include more, less, or different columns of interchange information. The “payment processing network” column may include one or more payment processing networks identified by network name, network code, etc. For each payment processing network listed: the “last full month column” may include an identifier (e.g., month and year) for the most recent complete month, the “previous month−1 transaction count” column may include the total number of transactions in the month two months prior to the last full month and processed by the network, the “previous month transaction count” column may include the total number of transactions in the month one month prior to the last full month and processed by the network, the “last full month” column may include the total number of transactions in the last full month and processed by the network, the “% change from 3 months before” column may include the percent change in the total number of transactions processed by the network when comparing the last full month with the month two months prior to the last full month, and the “% change from previous month” column may include the percent change in the total number of transactions processed by the network when comparing the last full month with the month one month prior to the last full month. Total values for one or more of the columns may also be included in the network level volume report 900.

FIG. 10 shows a merchant level volume report 1000 according to an embodiment of the invention. As shown in FIG. 10, the merchant level volume report 1000 may provide interchange information (e.g., network routing trends) to an issuer for specific merchants (e.g., Merchants A, B, and C). The merchant level volume report 1000 may include various columns including: “merchant,” “payment processing network,” “last full day,” “beginning month transaction count,” “previous day transaction count,” “last full day transaction count,” “% change beginning month,” and “% change previous day.” In embodiments of the invention, the merchant level volume report 1000 may include more, less, or different columns of interchange information. The “merchant” column may include one or more merchants identified by merchant name, merchant store, merchant chain, merchant code (e.g., a MVV), etc. For each merchant listed, the “payment processing network” column may include one or more payment processing networks identified by network name, network code, etc. For each payment processing network listed: the “last full day” column may include an identifier (e.g., the day, month, and year) of the last complete day, the “beginning month transaction count” column may include the total number of transactions processed by the network for the merchant on the first day of the current month, the “previous day transaction count” column may include the total number of transactions processed by the network for the merchant on the day before the last full day, the “last full day transaction count” column may include the total number of transactions processed by the network for the merchant on the last full day, the “% change beginning month” column may include the percent change in the total number of transactions processed by network for the merchant when comparing the last full day to the first day of the current month, and the “% change previous day” column may include the percent change in the total number of transactions processed by the network for the merchant when comparing the last full day to the day before the last full day. Total values for each merchant for one or more of the columns may also be included in the merchant level volume report 1000.

Embodiments of the invention provide a number of advantages to issuers and other entities. For example, by providing issuers with transaction data enriched with interchange data at the transactional level, and by providing issuers with reports based upon analysis of the enriched transaction data for transactions routed through a plurality of payment processing networks, issuers may be better able to track and monitor transaction routing decisions made by merchants. This may result in improved allocation of the issuers' internal resources. Since interchange reports may be provided on demand and include interchange revenue and expenses at various levels including the transaction level, cardholder level, terminal level, merchant level, merchant chain level, BIN level, payment processing network level, etc., issuers may be better able to manage their interchange revenue and expenses. Further, since individual transactions that do not comply with interchange regulations may be identified and reported to issuers in a timely manner, issuers may be able to more quickly and efficiently investigate potential non-compliant transactions to better meet the requirements of interchange regulations. These and other benefits may be provided by embodiments of the present invention.

V. Exemplary Computer Apparatuses

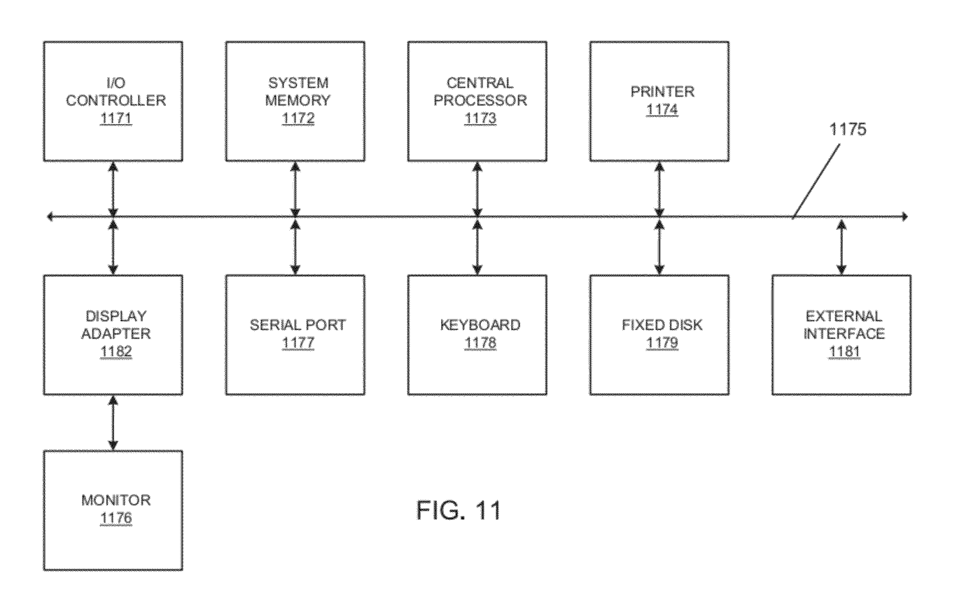

The various participants and elements may operate one or more computer apparatuses (e.g., a server computer) to facilitate the functions described herein. Any of the elements in the figures may use any suitable number of subsystems to facilitate the functions described herein. Examples of such subsystems or components are shown in FIG. 11. The subsystems shown in FIG. 11 are interconnected via a system bus 1175. Additional subsystems such as a printer 1174, keyboard 1178, fixed disk 1179 (or other memory comprising computer readable media), monitor 1176, which is coupled to display adapter 1182, and others are shown. Peripherals and input/output (I/O) devices, which couple to I/O controller 1171, can be connected to the computer system by any number of means known in the art, such as serial port 1177. For example, serial port 1177 or external interface 1181 can be used to connect the computer apparatus to a wide area network such as the Internet, a mouse input device, or a scanner. The interconnection via system bus 1175 allows the central processor 1173 to communicate with each subsystem and to control the execution of instructions from system memory 1172 or the fixed disk 1179, as well as the exchange of information between subsystems. The system memory 1172 and/or the fixed disk 1179 may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited in this patent are hereby incorporated by reference for all purposes.

One or more features from any embodiment may be combined with one or more features of any other embodiment without departing from the scope of the disclosure.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method comprising:
receiving, from a first payment processing network, an authorization request message for a first transaction;
transmitting, to an issuer computer, the authorization request message for the first transaction;
receiving, from the issuer computer, an authorization response message for the first transaction;
transmitting, to the first payment processing network, the authorization response message for the first transaction, wherein the authorization request message and the authorization response message for the first transaction include transaction data for the first transaction;
storing the transaction data for the first transaction;
receiving, from a second payment processing network, an authorization request message for a second transaction;
transmitting, to the issuer computer, the authorization request message for the second transaction;
receiving, from the issuer computer, an authorization response message for the second transaction;
transmitting, to the second payment processing network, the authorization response message for the second transaction, wherein the authorization request message and the authorization response message for the second transaction include transaction data for the second transaction;
storing the transaction data for the second transaction;
receiving, from the first payment processing network, a first interchange data file, wherein the first interchange data file includes interchange data for the first transaction;
receiving, from the second payment processing network, a second interchange data file, wherein the second interchange data file includes interchange data for the second transaction;
normalizing, by a server computer, the received first and second interchange data files; and
enriching, by the server computer, the stored transaction data with the received interchange data for the first and second transactions.

2. The method of claim 1 further comprising:
analyzing, by the server computer, the enriched transaction data for the first and second transactions; and
generating, by the server computer, a report based upon the analysis of the enriched transaction data for the first and second transactions.

3. The method of claim 2 further comprising transmitting the generated report to the issuer computer.

4. The method of claim 1, wherein the transaction data for the first transaction includes one or more of: a unique transaction identifier, an account number, a payment processing network code, a usage type code, a transaction mode code, a transaction type code, a merchant code, an ATM code, an acquirer code, an issuer code, a settlement amount, and an authorization category code for the first transaction, and wherein the transaction data for the second transaction includes one or more of: a unique transaction identifier, an account number, a payment processing network code, a usage type code, a transaction mode code, a transaction type code, a merchant code, an ATM code, an acquirer code, an issuer code, a settlement amount, and an authorization category code for the second transaction.

5. The method of claim 4, wherein the interchange data for the first transaction includes an interchange value for the first transaction, and wherein the interchange data for the second transaction includes an interchange value for the second transaction.

6. The method of claim 5 further comprising determining an interchange revenue value or an interchange expense value for the first transaction based upon the interchange value and the transaction data for the first transaction, and determining an interchange revenue value or an interchange expense value for the second transaction based upon the interchange value and the transaction data for the second transaction.

7. The method of claim 6, wherein enriching the stored transaction data with the received interchange data for the first transaction further comprises populating an interchange revenue field with the determined interchange revenue value for the first transaction or populating an interchange expense field with the determined interchange expense value for the first transaction, and wherein enriching the stored transaction data with the received interchange data for the second transaction further comprises populating an interchange revenue field with the determined interchange revenue value for the second transaction or populating an interchange expense field with the determined interchange expense value for the second transaction.

8. The method of claim 7, wherein the enriched transaction data for the first transaction includes the interchange revenue value or the interchange expense value for the first transaction and one or more of: the unique transaction identifier, the account number, the payment processing network code, the usage type code, the transaction mode code, the transaction type code, the merchant code, the ATM code, the acquirer code, the issuer code, the settlement amount, and the authorization category code for the first transaction, and wherein the enriched transaction data for the second transaction includes the interchange revenue value or the interchange expense value for the second transaction and one or more of: the unique transaction identifier, the account number, the payment processing network code, the usage type code, the transaction mode code, the transaction type code, the merchant code, the ATM code, the acquirer code, the issuer code, the settlement amount, and the authorization category code, for the second transaction.

9. The method of claim 1, wherein the transaction data for the first and second transactions is stored in a first format, and wherein normalizing the received first and second interchange data files comprises:
determining, by the server computer, a format of the first and second interchange data files, wherein the format of the first and second interchange data files is a second format; and
converting, by the server computer, the first and second interchange data files from the second format into the first format.

10. The method of claim 2, wherein analyzing the enriched transaction data for the first and second transactions comprises determining that an interchange revenue value for the first or second transaction fails to satisfy a stored criteria, and wherein the generated report includes an indication that the stored criteria is not satisfied for the first or second transaction.

11. The method of claim 2 further comprising transmitting the generated report to a report dashboard.

12. The method of claim 2, wherein the generated report is an interchange report providing interchange information at a transaction level, account level, cardholder level, terminal level, merchant store level, merchant chain level, BIN level, or a payment processing network level.

13. The method of claim 1 further comprising transmitting the enriched transaction data for the first and second transactions to the issuer computer.

14. The method of claim 1, wherein each operation is performed by a computer processor operatively coupled to a memory.

15. A non-transitory computer-readable medium embodying information indicative of instructions for causing one or more machines to perform the method claim 1.

16. A server computer comprising a processor and a non-transitory computer readable medium coupled to the processor, wherein the non-transitory computer readable medium comprises code executable by the processor for performing the method of claim 1.

17. A method comprising:
receiving, from a processor system, an authorization request message for a first transaction, wherein the processor system received the authorization request message for the first transaction from a first payment processing network;
generating an authorization response message for the first transaction;
transmitting, to the processor system, the authorization response message for the first transaction, wherein the processor system transmits the authorization response message for the first transaction to the first payment processing network, wherein the authorization request message and authorization response message for the first transaction include transaction data for the first transaction, and wherein the processor system stores the transaction data for the first transaction;
receiving, from the processor system, an authorization request message for a second transaction, wherein the processor system received the authorization request message for the second transaction from a second payment processing network;
generating an authorization response message for the second transaction; and
transmitting, to the processor system, the authorization response message for the second transaction, wherein the authorization request message and authorization response message for the second transaction include transaction data for the second transaction, and wherein the processor system:
transmits the authorization response message for the second transaction to the second payment processing network;
stores the transaction data for the second transaction;
receives, from the first payment processing network, a first interchange data file including interchange data for the first transaction;
receives, from the second payment processing network, a second interchange data file including interchange data for the second transaction;
normalizes, by a server computer, the received first and second interchange data files; and
enriches, by the server computer, the stored transaction data with the received interchange data for the first and second transactions.

18. The method of claim 17, wherein the processor system analyzes, by the server computer, the enriched transaction data for the first and second transactions, and wherein the processor system generates, by the server computer, a report based upon the analysis of the enriched transactions data for the first and second transactions.

19. The method of claim 18 further comprising receiving, from the processor system, the generated report.

20. The method of claim 17, wherein the transaction data for the first transaction includes one or more of: a unique transaction identifier, an account number, a payment processing network code, a usage type code, a transaction mode code, a transaction type code, a merchant code, an ATM code, an acquirer code, an issuer code, a settlement amount, and an authorization category code for the first transaction, and wherein the transaction data for the second transaction includes one or more of: a unique transaction identifier, an account number, a payment processing network code, a usage type code, a transaction mode code, a transaction type code, a merchant code, an ATM code, an acquirer code, an issuer code, a settlement amount, and an authorization category code for the second transaction.

21. The method of claim 20, wherein the interchange data for the first transaction includes an interchange value for the first transaction, and wherein the interchange data for the second transaction includes an interchange value for the second transaction.

22. The method of claim 21 wherein the processor system determines an interchange revenue value or an interchange expense value for the first transaction based upon the interchange value and the transaction data for the first transaction, and determines an interchange revenue value or an interchange expense value for the second transaction based upon the interchange value and the transaction data for the second transaction.

23. The method of claim 22, wherein enriching the stored transaction data with the received interchange data for the first transaction further comprises populating an interchange revenue field with the determined interchange revenue value for the first transaction or populating an interchange expense field with the determined interchange expense value for the first transaction, and wherein enriching the stored transaction data with the received interchange data for the second transaction further comprises populating an interchange revenue field with the determined interchange revenue value for the second transaction or populating an interchange expense field with the determined interchange expense value for the second transaction.

24. The method of claim 23, wherein the enriched transaction data for the first transaction includes the interchange revenue value or the interchange expense value for the first transaction and one or more of: the unique transaction identifier, the account number, the payment processing network code, the usage type code, the transaction mode code, the transaction type code, the merchant code, the ATM code, the acquirer code, the issuer code, the settlement amount, and the authorization category code for the first transaction, and wherein the enriched transaction data for the second transaction includes the interchange revenue value or interchange expense value for the second transaction and one or more of: the unique transaction identifier, the account number, the payment processing network code, the usage type code, the transaction mode code, the transaction type code, the merchant code, the ATM code, the acquirer code, the issuer code, the settlement amount, and the authorization category code for the second transaction.

25. The method of claim 17, wherein the transaction data for the first and second transactions is stored in a first format, and wherein normalizing the received first and second interchange data files by the processor system comprises:
determining, by the server computer, a format of the first and second interchange data files, wherein the format of the first and second interchange data files is a second format; and
converting, by the server computer, the first and second interchange data files from the second format into the first format.

26. The method of claim 18, wherein analyzing the enriched transaction data for the first and second transactions comprises determining that an interchange revenue value for the first or second transaction fails to satisfy a stored criteria, and wherein the generated report includes an indication that the stored criteria is not satisfied for the first or second transaction.

27. The method of claim 18 further comprising transmitting the generated report to a report dashboard.

28. The method of claim 18, wherein the generated report is an interchange report providing interchange information at a transaction level, account level, cardholder level, terminal level, merchant store level, merchant chain level, BIN level, or a payment processing network level.

29. The method of claim 17 further comprising transmitting the enriched transaction data for the first and second transactions to the issuer computer.

30. The method of claim 17, wherein each operation is performed by a computer processor operatively coupled to a memory.

31. A non-transitory computer-readable medium embodying information indicative of instructions for causing one or more machines to perform the method claim 17.

32. A server computer comprising a processor and a non-transitory computer readable medium coupled to the processor, wherein the non-transitory computer readable medium comprises code executable by the processor for performing the method of claim 17.
